(19) United States
(12) Patent Application Publication
(10) Pub. No.: US 2008/0084790 A1
(43) Pub. Date: Apr. 10, 2008

(54) CHILDREN'S ILLUSTRATIVE NIGHT AND DAY CLOCK

(76) Inventor: Diana McKee, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/835,575

(22) Filed: Aug. 8, 2007

Related U.S. Application Data
(60) Provisional application No. 60/821,716, filed on Aug. 8, 2006.

(51) Int. Cl. G04B 47/00

(52) U.S. Cl. 368/10

(57) ABSTRACT

Described herein is a children's clock for helping a child understand the difference between night and day and methods of use thereof.

### CROSS REFERENCE TO RELATED APPLICATIONS

This application claims priority upon U.S. provisional application Ser. No. 60/821,716, filed Aug. 8, 2006. This application is hereby incorporated by reference in its entirety for all of its teachings.

### BACKGROUND

Children go through a phase in which the child does not understand the difference between day and night. For example, children initially do not understand that nighttime is for sleeping. The child may wake up several times in the night calling for the parents or go into their room repeatedly to ask if it is time to get up. This is very wearing on the parents. A child's options for the determination of time when they are young is to guess, ask their parents, or see if it is dark or light outside. In the case of natural light, light coming through a window at dawn could be at 5:30 am, which may be too early for waking. Described herein is a clock that can be used as a tool to help a child understand how long night is and to learn the cycle of a day.

### SUMMARY

Described herein is a children's clock for helping a child understand the difference between night and day, which can ultimately help the child achieve a consistent sleep cycle. The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows the front view of one embodiment of a children's clock described herein.

FIG. 2 shows the front view of one embodiment of a children's clock described herein with the face of the clock removed.

FIG. 3 shows a schematic of timing mechanism with respect to controlling audio and video produced by the clock.

FIG. 4 shows the external features of a children's clock.

FIG. 5 shows the external features of the control base.

FIG. 6 shows the control base with timing mechanism, audio system, and video system.

FIG. 7 shows the cross-sectional view of a projector displaying an image on the faceplate of the clock.

FIG. 8 shows a projector displaying an image on the faceplate of the clock.

FIG. 9 shows the cross-sectional view of the clock with a rotating projector displaying an image on the side of the clock.

FIG. 10 shows a cross-sectional view of the side of the clock with light-emitting diodes.

FIG. 11 shows a schematic for concurrently activating the audio system, video system, and illumination of the sides of the clock.

### DETAILED DESCRIPTION

Before the present device and/or methods are disclosed and described, it is to be understood that the aspects described below are not limited to specific devices or methods, or uses as such may, of course, vary. It is also to be understood that the terminology used herein is for the purpose of describing particular aspects only and is not intended to be limiting.

It must be noted that, as used in the specification and the appended claims, the singular forms “a,” “an” and “the” include plural referents unless the context clearly dictates otherwise. Thus, for example, reference to “a bulb” includes one or more bulbs.

Described herein is a children's clock for helping a child understand the difference between night and day. In general, the children's clock provides an audio/visual tool for the child and the parent to help the child know when it is time to go to bed and when it is time to wake up. The clock described herein produces different audio and video displays and sounds associated with day and night. If the child is consistently exposed to the different displays and sounds, the child will eventually understand and differentiate day and night.

In one asepct, the children's clock comprises:
(a) a housing comprising a faceplate;
(b) a video system for displaying a visual image on the faceplate;
(c) an audio system; and
(d) a timing mechanism, wherein the timing mechanism is programmable to concurrently produce video images and audio associated with day, night, or both day and night.

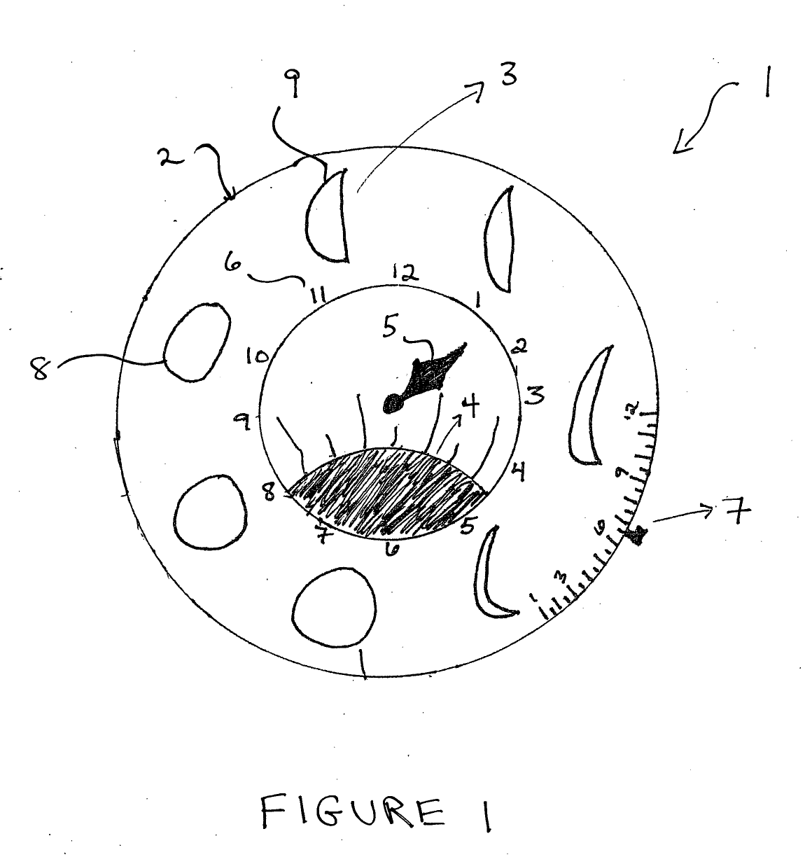

FIGS. 1-3 describe one aspect of the children's clock. FIG. 1 shows the front (i.e., face 2) of the children's clock 1. The face of the clock has a plurality of moon phases 3 at the outer perimeter of the face. In the center of the face is a depiction of the sun 4. The depictions of the moon and the sun are capable of being illuminated at specified times, which will be discussed below. Although FIG. 1 depicts the moon and sun, it is contemplated that other images associated with night and day can be present on the face of the clock. The location of the images can also vary on the face of the clock.

The clock depicted in FIG. 1 has a single dial 5. Although two dials are contemplated, the use of the single dial eliminates the confusion of having two dials, one for the hour and one for the minutes, which makes it easier for the child to read the clock. The single dial rotates and points to the appropriate illustration (e.g., moon 3) and time of day (depicted as 6 in FIG. 1). The face of the clock can be made of any durable material such as, for example, plastic. With respect to the nighttime and daytime images on the face of the clock (i.e., the moon phases and sun, respectively), the images are either transparent or opaque such that when light is shined behind them the image appears to be illuminated.

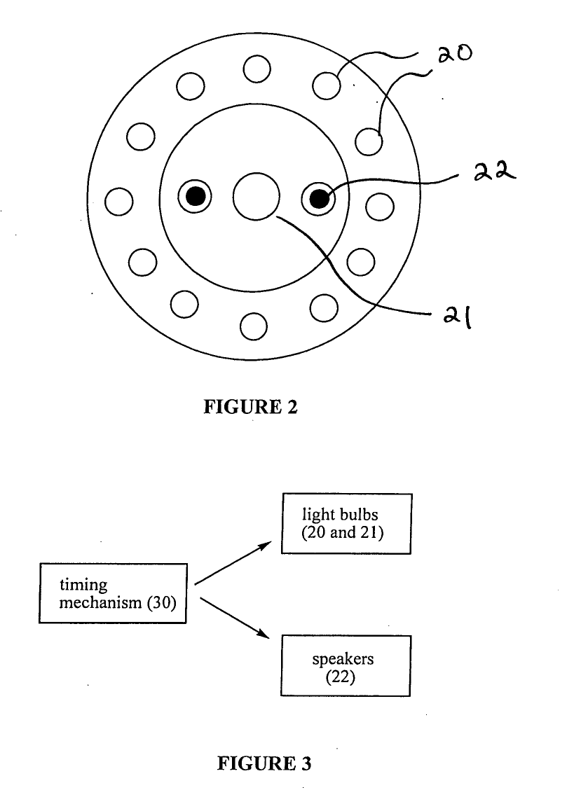

FIG. 2 depicts the clock with the face removed. Referring to FIG. 2, a plurality of light bulbs 20 are at or near the perimeter of the clock. These bulbs illuminate the different phases of the moon as depicted in FIG. 1 over timed intervals. Also depicted in FIG. 2 is a bulb 21 in the center of the clock. This bulb illuminates the sun over a specified period of time. It is contemplated that two or more bulbs can be placed in the center of the clock to illuminate the image of the sun in FIG. 1. The shape and size of the light bulbs can vary. Based upon the timing mechanism, the bulbs can be turned on and off or, in the alternative, they can be dimmed over time. Colored light bulbs are also contemplated

Also depicted in FIG. 2 are speakers 22. The audio output (e.g., types of sounds, the volume of the sound) is controlled by the timing mechanism. Different sounds can be projected from the speakers depending upon the time of day. For example, at nighttime, the speakers can produce the sound of crickets chirping. In another aspect, the sound of a rooster at sunrise can be played when it is time to wake up. Although the speakers are located behind the face of the clock in FIG. 2, it is also contemplated that the speakers can be mounted to the face as well.

FIG. 3 shows a schematic of the timing mechanism with respect to coordinating audio and video displays from the clock. The timing mechanism 30 concurrently controls the illumination of a particular video display on the face of the clock and specific sounds from the speakers. For example, referring to FIG. 1, at 10:00 pm the moon phase 8 will be illuminated by a light bulb 20 located behind the image. Over the next hour, the light bulb behind moon phase 8 will slowly dim and the light bulb behind moon phase 9 will slowly illuminate. Thus, at 11:00 pm, the moon phase 8 is no longer illuminated and moon phase 9 is fully illuminated. There is constant illumination of the clock; thus, the clock can also function as a night light for visibility. During the nighttime hours, the clock is producing sounds associated with the night (e.g., crickets chirping).

With the timing mechanism, parents can control when they want their child to wake up. In FIG. 1, the timing mechanism can be set by control 7. For example, if it is desired to wake the child at 6:00 am, the control 7 can be set at 6:00 am. When the timing mechanism is set, the bulb(s) 21 will illuminate the sun in the center of the clock and turn on audio associated with sunrise (e.g., sound of roosters or other birds). Timing mechanisms are commonly used in a number of children's toy and can be used herein. The clock can be powered by hand-held batteries or can be plugged into an outlet.

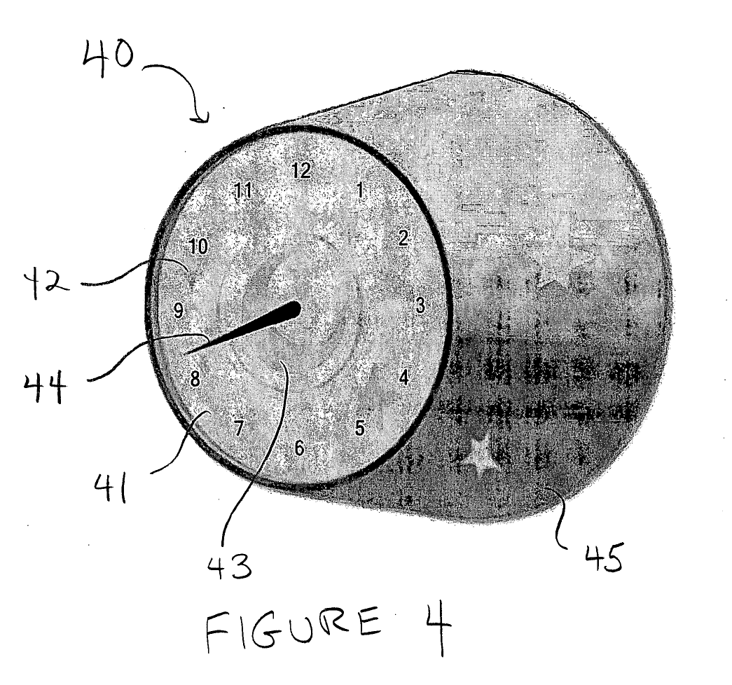

FIGS. 4-10 show another embodiment of the children's clock. Referring to FIG. 4, clock 40 is composed of a housing 45 and a faceplate 41. In this embodiment, the faceplate comprises a translucent material capable of displaying a visual image. In FIG. 4, the image of one or more stars 42 and the moon 43 are displayed on the faceplate. As will be discussed below, different images can be displayed on the faceplate depending upon the time of day. The translucent material can be composed of any durable plastic material. In certain aspects, the faceplate does not contain other screens or displays such as LCD screens. The faceplate 41 has numbers on the clock, which can be printed on or secured to the faceplate by techniques known in the art. Although only one hand 44 is depicted in FIG. 4, the clock can also have two hands. The faceplate 41 can be a variety of different shapes and sizes. In one aspect, the faceplate is circular and has a diameter greater than 12 inches.

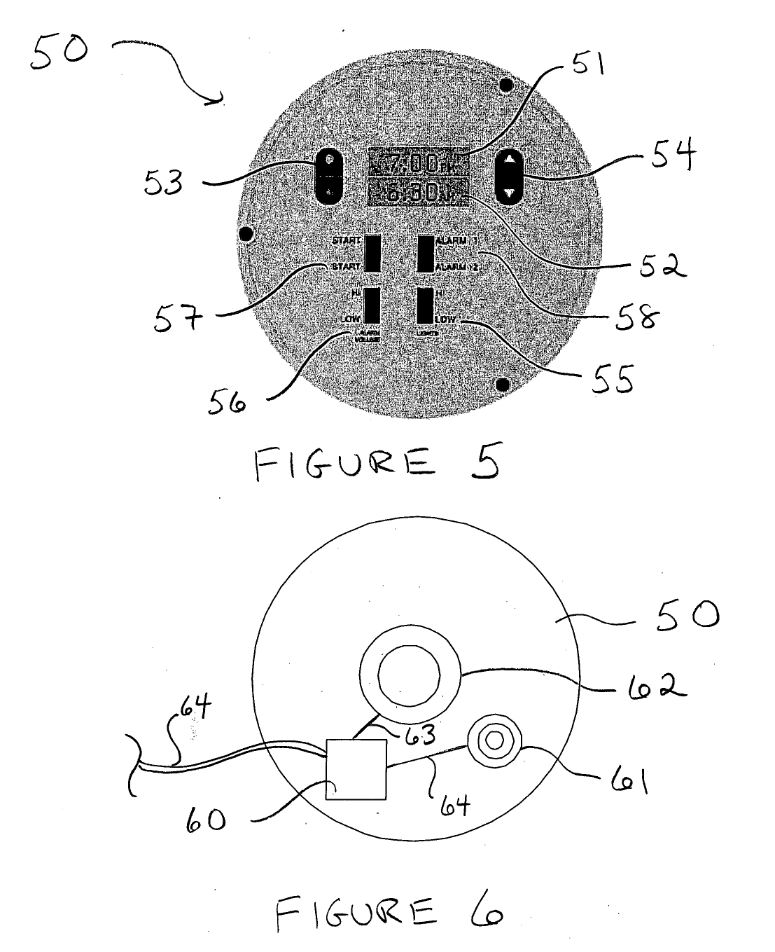

FIG. 5 shows the front-view of the control base 50 of clock 40. The control base 50 is attached to housing 45 by a series of screws or other fasteners known in the art. When the clock is to be mounted to a wall, the control base can be configured with one or more hooks or holes for securing the clock to the wall. In this aspect, the timing mechanism, the audio system, and the video system are attached to the control base 50. FIG. 6 shows a schematic of the backside of control base 50. The timing mechanism 60 is in communication with the speaker 61 and projector 62 by low voltage wire 63 and 64 or other related circuitry. The positioning of the timing mechanism 60, speaker 61, and projector 62 can vary based upon the design of the clock. Although FIG. 6 depicts one speaker, a plurality of speakers can be present in the clock. For example, one or more speakers can be mounted in the faceplate 41, the sides of the housing 45, or a combination thereof.

In addition to the components described above, a power supply can be mounted to the control base. For example, the control base can be configured to receive one or more disposable or rechargeable batteries. The power supply provides low voltage power to the timing mechanism 60. Alternatively, the clock can be powered by an external power source (e.g., 110 V outlet). As shown in FIG. 6, power cord 64 is wired to timing mechanism 60. However, power cord 64 can also be wired to projector 62 as well.

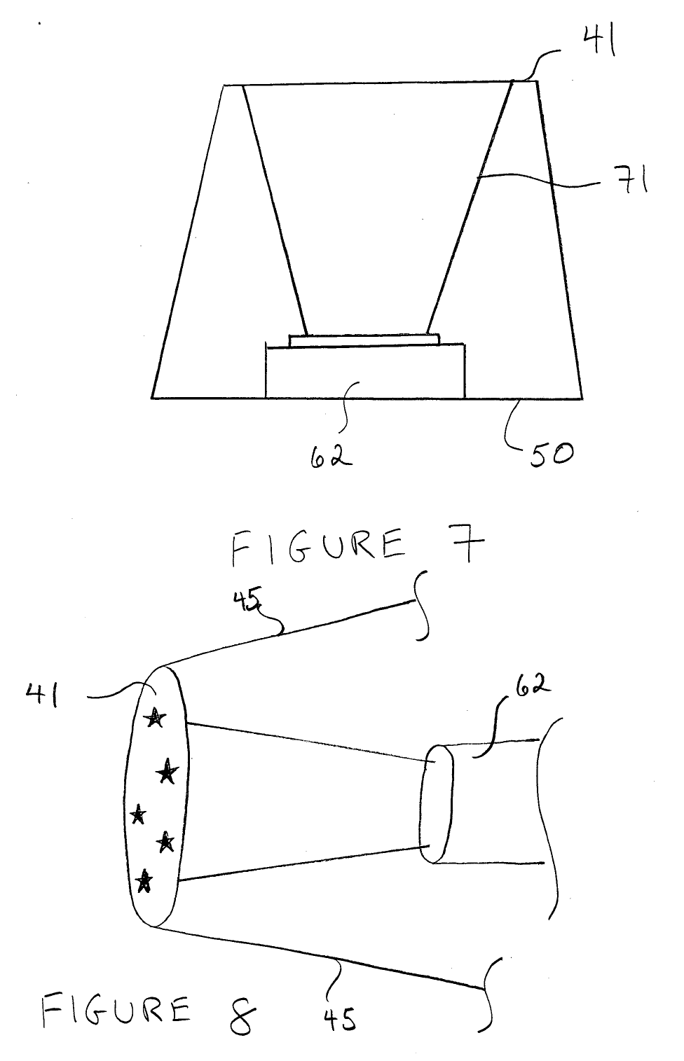

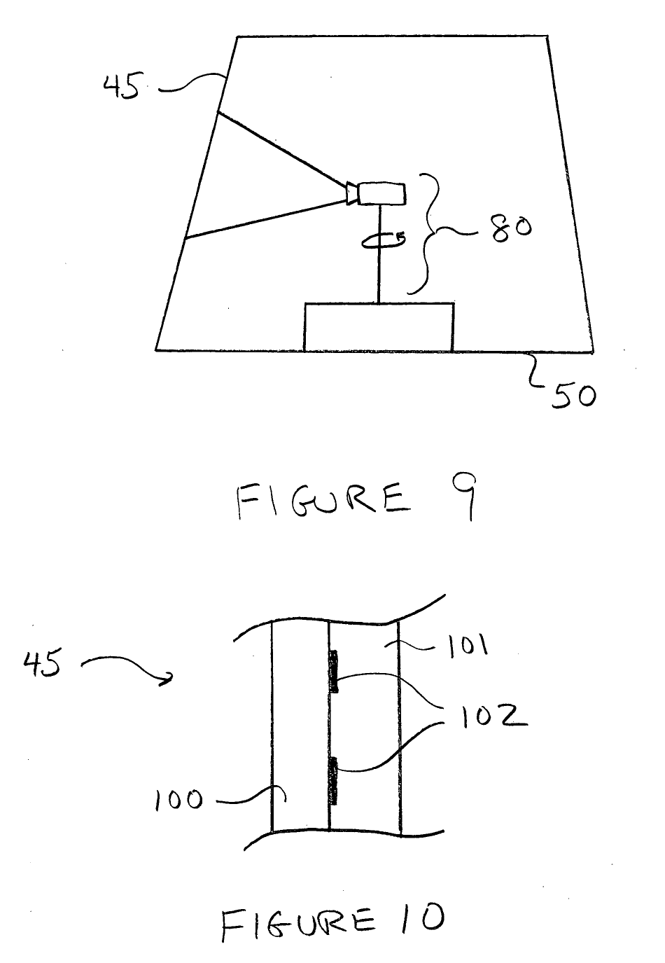

FIG. 7 shows a cross-sectional view of clock 40 with projector 62. FIG. 8 shows a side-view of the projector 62 displaying an image (e.g., stars) on faceplate 41. The projector 62 can be any device known in the art for producing and displaying visual images on faceplate 41. In one aspect, the projector shines light on a slide with an image, and the image is displayed on the faceplate. In this aspect, different slides can be rotated in front of the projector as controlled by the timing mechanism. Alternatively, the projector is a digital projector that directly produces a visual image without the use of slides.

Although FIGS. 7 and 8 depict one projector, multiple projectors can be used. In certain aspects, referring to FIG. 9, when housing 45 or portions thereof is produced with a translucent material, a rotating projector 80 can be mounted to control base 50 and project images on the housing (i.e., on the sides of the clock).

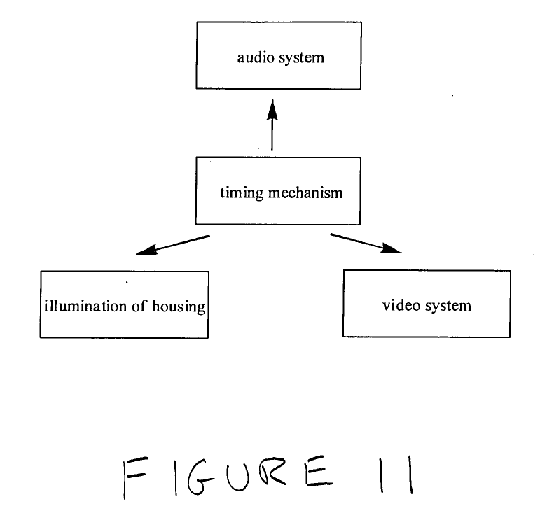

In other aspects, the housing can be illuminated by other means besides a projector. Referring to FIG. 10, which shows a cross-sectional view of side-wall of housing 45, a two layer system is present. The first layer 100, which is within the internal volume of the clock, is composed of a material that blocks the transmission of any light generated by the video system (e.g., a projector). The second layer 101 is composed of a translucent or opaque material. Embedded between layers 100 and 101 are a plurality of light-emitting diodes (LEDs) 102. The selection of the LEDs can vary depending upon the desired color of light. For example, a set of LEDs can be used to produce soft blue light during nighttime hours, while a different set of LEDs can be used bright, white light during the day. The LEDs are in communication with the timing mechanism so that they are activated at specific times of the day.

The children's clock described herein can vary in size and shape. The clock can be mounted to any wall by screws or other fasteners. The dimensions of the clock can vary, but will be generally be within the dimensions of standard wall or desk clocks. Alternatively, the clock can be attached to crib so that the clock is within view of the child.

The use of the children's clock is described. In general, the device through the timing mechanism concurrently produces audio and video images associated with day, night, and both day and night (FIG. 11). The term “concurrently” is defined herein as the simultaneous production of audio and video images associated with day and night. In the case when the sides of the clock are illuminated as well, the timing mechanism also concurrently illuminates the sides of the clock as described above. Referring to FIG. 5, two LCD screens (51 and 52) display times for waking up (52) and going to bed (51). The times can be changed with control buttons 53 and 54. Other settings such as video and audio intensity can be modified with control buttons 55 and 56, respectively. In certain situations, it is desirable that the clock is only activated at one particular time (e.g. bedtime). In this situation, control buttons 57 and 58 can be used to control this function.

When it is time to put the child to bed (e.g. 7:00 pm in display 51), the timing mechanism will instruct the audio system (e.g., projector) to produce images associated with night on the faceplate of the clock. Examples of such images include, but are not limited to, stars and the moon. Concurrently, the timing mechanism also instructs the audio system to produce sounds associated with night (e.g., crickets chirping). Finally, the timing mechanism instructs certain LEDs to produce a soft light (e.g., blue) on the sides of the clock, which is conducive to sleeping. In summary, the clock produces a series of video and audio signals that help the child fall asleep. In certain aspects, when the clock is set for nighttime, no audio is produced.

When the clock is set to wake the child (e.g., 6:30 am in display 52), images of daytime (e.g., the sun, birds, etc.) are produced on the faceplate of the clock. The audio system produces sounds associated with daybreak such as, for example, the chirping of birds. The timing mechanism also activates a set of LEDs to produce white light. In certain aspects, these LEDs can be set on a dimmer so that the intensity of the white light grows over time to imitate the rise of the sun.

The child learns to rely on the images on the clock to understand the passing of a full night and day, just as they learn to look at the illustrations in a book to tell a story. They also learn from the clock the different sounds associated with night and day. The clock optionally includes numbers as well for when the child is developmentally ready to begin reading numbers and understanding the concept of time associated with day and night. Thus, the child can grow with the clock.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. A children's clock comprising
(a) a housing comprising a faceplate, wherein the faceplate comprises a translucent material;
(b) a video system for displaying a visual image on the faceplate;
(c) an audio system; and
(d) a timing mechanism, wherein the timing mechanism is programmable to concurrently produce video images and audio associated with day, night, or both day and night.

2. The clock of claim 1, wherein the housing comprises a control base, wherein the timing mechanism, the audio system, and the video system are mounted on the control base.

3. The clock of claim 2, wherein the control base comprises two control systems for programming the timing mechanism.

4. The clock of claim 1, wherein the clock comprises one hand.

5. The clock of claim 1, wherein the audio system comprises one or more speakers mounted in a control base.

6. The clock of claim 1, wherein the video system comprises one or more projectors.

7. The clock of claim 6, wherein the projector comprises a digital projector.

8. The clock of claim 1, wherein the video system further comprises one or more projectors for displaying an image on the sides of the housing.

9. The clock of claim 1, wherein one or more sides of the housing comprises a means for illuminating the side at a specified time or duration.

10. The clock of claim 9, wherein the means for illuminating the sides comprises a plurality of light-emitting diodes.
